(19) United States
(12) Patent Application Publication
(10) Pub. No.: US 2025/0146514 A1
(43) Pub. Date: May 8, 2025

(54) METHOD FOR CONTROLLING A COMPRESSED AIR SUPPLY DEVICE AND A COMPRESSED AIR SUPPLY DEVICE FOR A COMPRESSED AIR SYSTEM OF A UTILITY VEHICLE

(71) Applicant: ZF CV SYSTEMS GLOBAL GMBH, Bern (CH)

(72) Inventors: Leon BAASKE, Hannover (DE); Marcin CHAMOT, Wroclaw (PL); Ahmadulla KHAN, Hannover (DE); Kevin PENDZICH, Hannover (DE); Rudolf DÜCKMANN, Isernhagen (DE)

(21) Appl. No.: 18/939,079

(22) Filed: Nov. 6, 2024

(30) Foreign Application Priority Data
Nov. 7, 2023 (EP) 23208391.5

(51) Int. Cl. F15B 1/26; B01D 53/26; B01D 53/30; B60T 17/00; B60T 17/02; B60T 17/06

(52) U.S. Cl. CPC F15B 1/265; B01D 53/26; B01D 53/30; B01D 2257/80; B01D 2258/06; B01D 2259/4566; B60T 17/004; B60T 17/02; B60T 17/06

(57) ABSTRACT

A method for controlling a compressed air supply device of a compressed air system of a utility vehicle. The compressed air supply device has a compressor, an air dryer unit and a regeneration valve device and being operated in an operating mode with delivery phases and regeneration phases. In the method, a current humidity, e.g. a relative or absolute humidity, is ascertained in the compressed air system, a current dew point depression (c-DPD) is ascertained from the ascertained humidity, a target dew point depression (t-DPD) is ascertained from current and/or projected ambient temperature data (T0, T(t)) and/or from current and/or projected vehicle operating data, and a target dew point depression (t-DPD) is subsequently ascertained from current and/or projected ambient temperature data (T0, T(t)) and compared with the current dew point depression (c-DPD). The operating mode and/or the regeneration phases are subsequently set and/or changed.

Method for controlling a compressed air supply device and a compressed air supply device for a compressed air system of a utility vehicle.

The invention relates to a method for controlling a compressed air supply device and a compressed air supply device of this type for a compressed air system of a utility vehicle.

A compressed air supply device in a utility vehicle generally has a compressor, which takes in and compresses air, and a subsequent air dryer unit, which cleans and dries the supplied compressed air so that the dried compressed air is guided to an outlet region of the air dryer unit.

A consumer stage with consumer circuits, in which the delivered compressed air is stored in compressed air reservoirs, is generally connected to the outlet region via a multi-circuit protection valve device. In delivery phases, compressed air therefore makes its way through the dryer unit and into the outlet region; in regeneration phases, the compressed air is returned from the outlet region via a regeneration valve device, partially expanded and guided backwards through the air dryer unit in order to remove its moisture. The degree of drying of the compressed air may therefore be set by setting the regeneration phases, i.e. the length of the regeneration phases and the number thereof.

The dew point, i.e. the dew point temperature, indicates the temperature at which moisture precipitates in an airvapor mixture. The dew point is therefore a measure of the absolute humidity in the air volume. The dew point depression represents the depression of the dew point which is achieved, in particular, by reducing the humidity and is defined relative to the ambient temperature. The dew point depression is therefore a performance indicator or power indicator for an air dryer unit and the compressed air supply device. A sufficiently high dew point depression may prevent moisture condensing in the subsequently stored compressed air. In particular, the regeneration phases are therefore set in such a way that a high dew point depression occurs and the risk of water condensing may be decreased.

However, the regeneration phases result in an energy loss in each case, since previously delivered compressed air is in turn discharged from the system. Therefore, a high dryer power, i.e. with long regeneration phases, is generally set in the control of the regeneration phases in order to ensure the necessary safety, albeit generally with a relatively high energy consumption.

DE 10 2010 018 949 A1 describes a compressed air conditioning device and a compressed air supply system and a method for the operation thereof, a vent line with a pneumatically actuable vent valve, which connects a regeneration path, being arranged between a compressed air inlet of the compressed air conditioning device, to which the compressor can be connected, and a dryer device. It is provided herein that the quantity of moisture introduced into the dryer device is ascertained or estimated by a humidity sensor or by estimating the quantity of air which has flowed through in the delivery direction.

CA 2073439 C describes the mounting of a humidity sensor in a downstream compressed air reservoir.

DE 10 2010 025 890 A1 describes a control device for an air conditioning system of a vehicle for initiating different operating phases of the air conditioning system, the control device receiving external measurement signals containing information relating to a state of the ambient air, in particular the temperature and the relative humidity and/or absolute humidity of the ambient air, the external measurement signals being formed on the basis of measurement signals of a sensor of the internal combustion engine, which may be, in particular, a humidity sensor. From the external measurement signal, an absolute quantity of water in the ambient air taken in by the air conditioning system may be ascertained through time integration and compared with the intake capacity of an air dryer in order to set regeneration phases subject to the comparison.

DE 3 727 603 A1 describes a compressed air conditioning device for compressed air systems, in particular for compressed air brake systems, in which an air dryer can be switched from an operating setting to regeneration mode for removing moisture from a drying agent by connecting the air dryer to a regeneration air reservoir. Repeated regeneration of the drying agent takes place to achieve a greater dew point depression, the switching valve being connected to the outlet of the air dryer for reliable switching of the air dryer and being switched when an upper and lower pressure limit value in the regeneration air reservoir is reached. The switching cycle of the air dryer from its regeneration phase to its drying phase may be set via a time relay or controlled by a moisture sensor, which detects the moisture in the drying agent in the container of the air dryer.

WO 2017 157 503 A1 describes a drying device of a compressed air supply system of a vehicle, having a delivery inlet, a delivery outlet, a regeneration inlet and a vent outlet and two parallel dryer lines, each with a dryer unit and a switching valve for switching between a delivery mode and a regeneration mode of the two dryer units, which are operated alternately. Humidity levels of the dried compressed air are recorded by humidity sensors in the outlets of the dryer lines or in a common outlet line; pressure differences upstream and downstream of the dryer units are furthermore measured and used to activate a pilot valve of the switching valve, a regeneration valve or a compressor control valve. A total humidity of both dryer units is ascertained from the humidity of the dryer units, a switch taking place subject to an upper humidity threshold and a lower humidity threshold.

The invention is based on the object of providing a method for controlling a compressed air supply device and a compressed air supply device of this type, which enable a high dryer power with low energy consumption.

This object is achieved by a method and a compressed air supply device according to the independent claims. The dependent claims describe preferred developments. Furthermore, a compressed air system and a utility vehicle having the compressed air supply device are provided.

The method according to the invention may be carried out, in particular, by a compressed air supply device according to the invention and/or a compressed air system according to the invention; the compressed air supply device according to the invention is provided, in particular, for carrying out the method according to the invention.

Therefore, an operating mode of the compressed air supply device is set subject to at least one ascertained current dew point depression and a target dew point depression; the operating mode influences or alters preferably at least the number and/or length of the regeneration phases here.

The setting or specification of the operating mode therefore also corresponds, in particular, to a change in operating mode if a change in relation to the current operating mode is ascertained during the evaluation of the comparison.

Therefore, not only is the humidity measured and used to control and regulate the regeneration phases, but an operating mode is selected subject to the comparison between a current and a target dew point depression.

According to the invention, several advantages are achieved. According to the invention, in contrast to regulation based on humidity measurements, as provided in the method mentioned at the outset, and also in contrast to a fixed dew point depression, which, for safety reasons, is selected to be sufficiently high to prevent water accumulating in the consumer circuits under differing ambient conditions, the dew point depression may be adapted such that sufficient capacity to dry the compressed air is achieved on the one hand whilst, on the other, good energy efficiency is also enabled since unnecessarily high dew point depressions may be avoided. In particular, it is recognized here that, to this end, essentially only data which are either already available or which may be recorded with little effort are required.

In contrast to existing systems, the method according to the invention therefore requires essentially no, or no notable, intervention in the hardware design. Appropriate programming or setting of the control unit, which sets or regulates the regeneration phases appropriately, may advantageously take place.

The current dew point depression is preferably ascertained by measuring the humidity in the compressed air system, in particular in the compressed air supply device and/or in a subsequent consumer stage.

According to a preferred design, the operating mode influences or alters the duration and/or number of the regeneration phases, and possibly also the delivery phases and/or idle phases. In particular, the starting point and end point of the regeneration phases may be set here. In this regard, an operating mode between a lower value with high energy efficiency and a low capacity and a high value with a high capacity and low energy efficiency, i.e. a relatively high energy consumption, may be selected. An air dryer which is dried to a greater extent due to longer regeneration phases, i.e. in particular with more moisture removed from the regeneration agent, enables better drying of the compressed air, which is reflected, in particular, in a higher dew point depression of the delivered compressed air; however, longer regenerations increase the energy requirement. Therefore, greater regeneration of the air dryer unit, and therefore a greater capacity, may be achieved through longer and/or more frequent regeneration phases, and greater energy efficiency may be achieved accordingly by decreasing the duration and/or occurrence of the regeneration phases.

The current dew point depression may be ascertained, in particular, by firstly ascertaining a current dew point from the ascertained humidity and then ascertaining the current dew point depression from the current dew point and the ambient temperature.

The humidity may be measured at various points, e.g. at an outlet region of the compressed air supply device between the air dryer unit and the consumer circuits of a subsequent consumer stage, and/or in a regeneration path. Direct measurement of the humidity is therefore enabled after the exit from the air dryer unit or before the return of the compressed air during the regeneration.

Furthermore, humidity sensors may also be provided in the consumer stage, e.g. in one of the consumer circuits, e.g. one of the service brake circuits, so that the humidity of the stored compressed air is ascertained directly in the most relevant consumer circuits, e.g. also in the compressed air reservoirs of these consumer circuits, in order to detect the risk of condensate separation.

A relative humidity or an absolute humidity may be ascertained as the humidity value. The measurement of relative humidity is often more simple in terms of the sensor technology, it being possible to subsequently ascertain the absolute humidity and the dew point, in particular subject to the temperature.

To ascertain the target dew point depression, ambient temperature data, in particular, are included. To this end, current ambient temperature data are advantageously firstly included to give a dew point depression relative to the current ambient temperature. According to advantageous embodiments, projected or future ambient temperatures, in particular in the respective position or location of the vehicle, may be furthermore or even alternatively used. As a result, too high a dew point depression may be avoided since, for example, a significant drop in the ambient temperature, e.g. overnight, may therefore be taken into account or ruled out. In this regard, for example, a high future, i.e. projected, overnight ambient temperature drop alone may essentially be relevant for ascertaining the target dew point depression, without the current ambient temperature drop being relevant in this case.

To ascertain the target dew point depression, projected vehicle operating data, in particular, may also be included, which are, in particular, one or more elements from the group comprising: air consumption of vehicle systems, e.g. of air springs, brake systems, gear actuators, vehicle speed, journey length, route planning, projected duration of vehicle standstills and/or times of vehicle standstills.

This enables, in particular, the expected heating of the compressed air system to be taken into account for an upcoming journey. In this regard, the temperature in the vehicle and compressed air system increases, in particular when using the compressor, but also due to the engine and other consumers, so that the ambient temperature here is possibly not relevant or is not relevant to the same extent as when a vehicle is at a standstill, and possibly only the operating data are relevant. In particular, unnecessary dew point depressions may therefore be avoided.

According to a particularly advantageous embodiment, projected, future, position data, in particular map data of one or more planned journeys, i.e. including mapping data, are also taken into account. Therefore, a planned journey of the utility vehicle is taken into account, it being possible to ascertain the ambient temperature for the positions of the journey in each case, in particular also taking into account the altitude and time of day. Therefore, when traveling over a mountain pass, for example, the corresponding temperature drop for the time of day and/or altitude may be taken into account, and furthermore an overnight temperature drop. The target dew point depression may already be appropriately ascertained from this, i.e. in particular too high a dew point depression may also be avoided.

The operating mode may be ascertained taking into account a target energy efficiency and a target capacity; therefore, the most relevant requirements are included in order to determine an appropriate operating mode, e.g. on a linear scale between a low value with a low capacity—which is therefore economical and highly energy efficient—and a high value with a high capacity.

According to a preferred embodiment, during the comparison, a DPD deviation is ascertained as a difference between the target dew point depression and the current dew point depression, and the operating mode is set subject to the DPD deviation. Therefore, the operating mode may be selected directly and clearly, e.g. by associating the values of the DPD deviation with respective operating modes, and rapid adaptation may therefore take place. To this end, the DPD deviation may be divided into multiple classes or groups, e.g. including a lower limit value and an upper limit value between which a range of around zero is formed, which does not require a change to the current operating mode, and ranges above and below the limit values, it being possible, for example, to also provide more than one upper limit value in order to possibly achieve a rapid increase in performance. Reliable categorization with clearly specified activations of the regeneration phases is therefore ensured, along with a dynamic response behavior to the ascertained DPD deviation.

According to a preferred embodiment, the compressed air requirement is furthermore ascertained, e.g. by measuring the pressure in the consumer circuits. Therefore, regulation takes place not only according to the dew point depression, but also according to the compressed air requirement. As a result, in particular, the delivery phases may also be set in addition to the regeneration phases.

Accordingly, a compressed air supply device is created, in particular with the control unit designed for this, and also a compressed air system having the compressed air supply device and the consumer circuits. In particular, one or more humidity sensors, and advantageously also a pressure sensor, are additionally provided here to ascertain the requirement.

The invention is explained in more detail below with reference to the accompanying drawings relating to several embodiments. In the drawings:

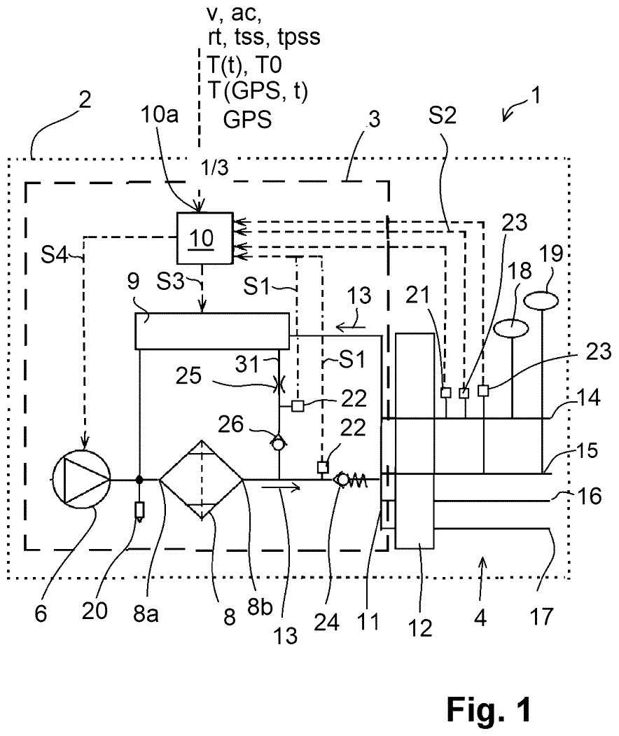

FIG. 1 shows a compressed air system of a utility vehicle with a compressed air supply device, according to an embodiment of the invention;

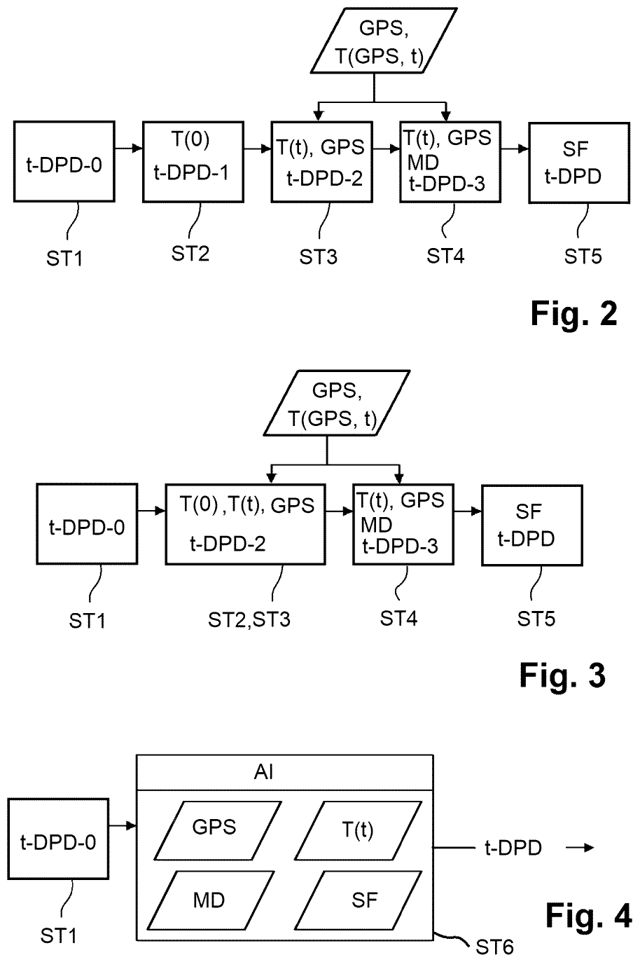

FIG. 2 shows a flow chart of the process steps for determining a target dew point depression for a method for controlling a compressed air supply device according to an embodiment of the invention;

FIG. 3 shows a further flow chart of the process steps for determining a dew point depression according to an embodiment of the invention;

FIG. 4 shows a further flow chart of the process steps for determining the dew point depression according to an embodiment of the invention;

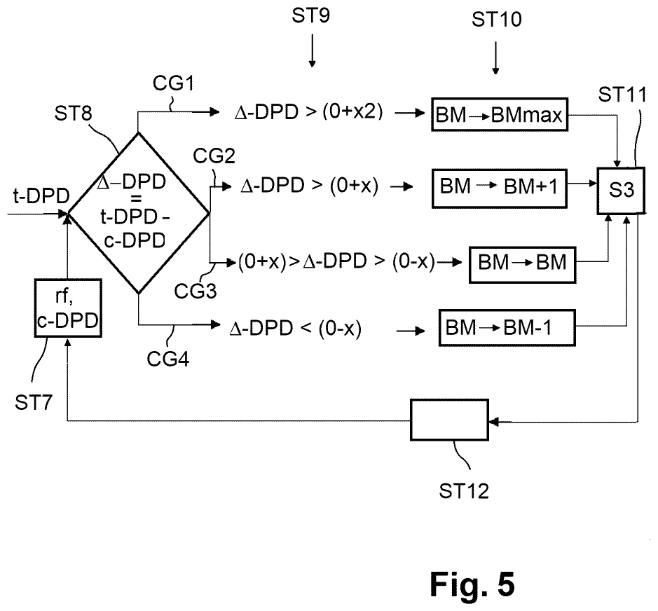

FIG. 5 shows a flow chart of a method for controlling a compressed air supply device according to an embodiment.

According to FIG. 1, a compressed air system 2, which has substantially one compressed air supply device 3 and a consumer stage 4 with consumer circuits 14, 15, 16, 17, is provided in a utility vehicle 1. The compressed air supply device 3 has substantially one compressor 6, an air dryer unit 8 with a dryer inlet 8a and a dryer outlet 8b, a regeneration valve device 9 and an electronic control unit ECU 10. The compressor 6 delivers compressed air 13 through the air dryer unit 8 in delivery phases via a first non-return valve 24 to an outlet region 11 of the compressed air supply device 3, which subsequently conducts it to the individual consumer circuits via a multi-circuit protection valve 12 of the consumer stage 4, four consumer circuits 14, 15, 16, 17, e.g. including service brake circuits 14, 15, being shown by way of example in FIG. 1. The compressed air 13 which is delivered and dried in this way is stored in compressed air reservoirs, e.g. the compressed air reservoirs 18, 19 of the service brake circuits 14, 15. In regeneration phases, by activating the regeneration valve device 9, previously delivered and dried compressed air 13 is conducted back from the outlet region 11 via the regeneration valve device 9 and a regeneration path 31 having a throttle 25 and a second non-return valve 26 and through the air dryer unit 8 via the dryer outlet 8b, and is discharged at a compressed air outlet 20 via the dryer inlet 8a. In addition to the delivery phases and regeneration phases, idle phases without delivery and regeneration are generally also provided. The control, i.e. the initiation and termination of the delivery phases, regeneration phases and idle phases, takes place by means of the electronic control unit 10, which, to this end, activates the regeneration valve unit 9, in particular, and possibly the compressor 6. Different designs of the compressor 6 are possible: in a utility vehicle 1 with an internal combustion engine, the compressor 6 is generally arranged on the engine shaft 1, e.g. via a clutch, so that the ECU 10 activates the clutch in order to switch the compressor 6 on and off; the compressor 6 may furthermore be deactivated by the ECU 10 by switching it to idle mode. In utility vehicles with electric drives, a compressor 6 may also be switched on and off directly, for example.

At least one humidity sensor 22, 23, which measures a humidity value of the delivered compressed air 13 and outputs a humidity measurement signal S1 to the ECU 10, is provided in the compressed air system 2. In particular, the humidity sensor 22, 23 may measure the relative humidity of the compressed air 13 here; however, an absolute humidity value may also be measured. To this end, an internal humidity sensor 22 is preferably provided in the compressed air supply device 3, in particular in the outlet region 11 and/or between the dryer outlet 8b and the first non-return valve 24 and/or in the regeneration path 31, e.g. between the throttle 25 and the second non-return valve 26. Furthermore, one or more external humidity sensors 23 may be provided in the consumer stage 4, e.g. in the compressed air reservoirs 18, 19 of the two service brake circuits 14, 15. In addition, a pressure sensor 21, which outputs a pressure measurement signal S2 which may be used to estimate the compressed air requirement, is preferably provided on at least one of the consumer circuits, e.g. one service brake circuit 14 or both service brake circuits 14, 15. The compressed air requirement may furthermore also be ascertained from a theoretical ascertainment on the basis of the delivery phases, regeneration phases and the consumption by the compressed air consumers.

The ECU firstly sets an operating mode BM, e.g. on a discrete scale between a minimum and maximum value, which represents, for example, the capacity or performance of the compressed air supply device 3, i.e. the drying capability in the regeneration phase. The duration and/or number of the regeneration phases may therefore be increased, e.g. in a higher operating mode. From the humidity signal S1, in particular, the ECU 10 ascertains a current dew point DP, i.e. a dew point temperature (in degrees Celsius), and a current dew point depression c-DPD as a temperature difference (in Kelvin), which therefore describes the capacity, since an air dryer unit 8 which is better regenerated is able to remove more moisture from the compressed air 13.

The flow charts of FIGS. 2 to 5 show various embodiments with process steps for ascertaining the dew point depression for the method for controlling the compressed air supply device.

According to FIG. 2, in a step ST1, an initial target dew point depression t-DPD-0 is specified; the initial target dew point depression t-DPD-0 may be stored e.g. as a fixed value, e.g. t-DPD-0=30 K (Kelvin).

Subsequently, in step ST2, a first modified target dew point depression t-DPD-1 is ascertained, in particular in that a current ambient temperature T(0) is used by the ECU 10 via its interface; therefore, in particular, a high dew point depression is avoided if condensate is not expected to form in the consumer circuits 14 to 17 at the current ambient temperature T(0).

Subsequently, in step ST3, the first modified target dew point depression t-DPD-1 ascertained in this way is modified again with the inclusion of a predicted (projected) ambient temperature T(t), i.e. the ambient temperature as a function of time, so that a second modified target dew point depression t-DPD-2 is ascertained. The predicted (projected) ambient temperature T(t) over a time period of 24 h may preferably be used here, so that, in particular, an overnight temperature drop of the ambient temperature is also taken into account. Furthermore, the current position may be taken into account as position data, e.g. GPS data, it also being possible to take into account the altitude (above sea level) along with the geographical position.

In addition or alternatively, current and/or projected vehicle operating data may also be included in the ascertainment of the second modified target dew point depression t-DPD-2, and/or a third modified target dew point depression may be ascertained from the vehicle operating data. In particular, an air consumption of vehicle systems, e.g. of air springs, brake systems, gear actuators, and also a vehicle speed v, journey time rt, route planning, projected durations tss and/or times tpss of vehicle standstills, may be used as relevant vehicle operating data here.

In step ST4, the second (or third) modified target dew point depression t-DPD-2 is then modified again with the inclusion of mission data MD, i.e. in particular planned journeys, and a third modified target dew point depression t-DPD-3 is therefore ascertained. Position data, i.e. in particular GPS data for the route corresponding to the mission data, are in turn taken into account here.

In this regard, for example, a position with the lowest temperature on the planned routes may be used, e.g. a mountain pass, since very low temperatures may occur there; the third modified target dew point depression t-DPD-3 may therefore be ascertained, e.g. taking into account the projected minimum ambient temperature T(t, GPS). Therefore, a temperature profile according to the environment, in particular the altitude above sea level, may be used. Furthermore, the projected compressed air requirement may be taken into account, for which the route profile and, furthermore, vehicle data, in particular a vehicle load, are in turn used to determine the expected compressed air requirement from this.

Subsequently, in step ST5, a safety factor SF, of e.g. SF=20%, is taken into account in the third modified target dew point depression t-DPD-3 in order to increase the safety so that the ultimately calculated target dew point depression t-DPD is subsequently output, which is then used in FIG. 5 for determining the operating mode BM.

According to a preferred design, the determination of the target dew point depression t_DPD only takes place when all steps ST2 to ST5 may be carried out. For safety reasons, if one of the steps fails, a dynamic target dew point depression is not carried out; rather, the fixed target dew point depression, i.e. the initial target dew point depression t-DPD-0 of e.g. 30 K, specified in step ST1, is specified.

According to the embodiment of FIG. 3, the steps ST2, ST3 are combined, i.e. a projected or predicted ambient temperature for the position data GPS corresponding to the planned mission or mission data is taken into account. It may therefore be taken into account, for example, that a vehicle will travel along a mountain pass at midday, when the ambient temperature T(t, GPS) is relatively high, which means that, for example, a relatively low target dew point depression t-DPD may be specified. It should in turn be taken into account here that the precise association between times and map data or GPS data is uncertain, since delays due to traffic congestion may occur, which means that additional regional data should possibly be specified here for the association between position and time.

According to the embodiment of FIG. 4, a first modification firstly takes place with the inclusion of the current ambient temperature T(0), so that a first modified target dew point depression t-DPD-1 is in turn ascertained. Subsequently, in step ST7, the determination of the target dew point depression t-DPD takes place using an AI algorithm (artificial intelligence), which uses and automatically calculates the input data taken into account in steps ST3 to ST5 in FIG. 2, 3, in particular using an automatic learning technique. Therefore, in step ST7, the following input data may be used:
position data, in particular GPS data GPS, including information about the altitude,
projected, predicted environmental data, i.e. in particular the ambient temperature T(GPS, t),
mission data MD or map data,
in turn preferably with the inclusion of the safety factor SF.

According to a modified embodiment, the first modification of the step ST2 may furthermore also be additionally included in the AI algorithm.

According to a further modified embodiment, instead of step ST1, i.e. instead of the fixed starting value of the target dew point depression t-DPD-0, a value of the initial target dew point depression t-DPD-0 may be learned by the AI algorithm, i.e. step ST1 is also included in step ST6.

FIG. 5 shows an embodiment of the subsequent regulation or setting of the operating mode BM on the basis of the target dew point depression t-DPD previously ascertained in FIGS. 2 to 4. Therefore, the target dew point depression t-DPD is included from the left in step ST5 or ST6. Furthermore, in step ST7, a current dew point depression c-DPD is ascertained on the basis of the measured humidity rf, or an absolute humidity, which is ascertained via the measured relative humidity.

The deviation between the currently measured dew point depression c-DPD and the target dew point depression t-DPD, which has not yet been reached, is ascertained here. If, at the time, the air dryer unit 8 therefore contains too much moisture and has therefore not achieved a sufficient dew point depression c-DPD, the regeneration phases have to be extended and/or carried out more frequently, which therefore leads to a higher power being set. If, on the other hand, the current dew point depression c-DPD is higher than the target dew point depression t-DPD, the regeneration phases are shortened and/or carried out less frequently, which results in an improvement in the energy efficiency.

According to the embodiment shown in FIG. 5, not only does direct activation of the regeneration valve device 9 take place, but advantageously a change of the current operating mode BM, preferably to an operating mode which results in the target dew point depression t-DPD. In step ST8, a DPD deviation Delta-DPD is ascertained as the difference

$$Delta - DPD = t - DPD - c - DPD .$$

The DPD deviation Delta DPD is then evaluated or classified in an evaluation step ST9, e.g. through comparison with a lower limit value 0−x, a first upper limit value 0+x and a second upper limit value 0+X2 here, with X2>X1, so that a regulation step ST10, which results in a new operating mode BM, then takes place for each case group CG1 to CG4.

First, upper case group CG1: Delta-DPD>>0+X, which is ascertained as Delta-DPD>0+X2, with X2>X1, i.e. the performance or capacity is very low.

According to step ST11-1, the operating mode MB is increased to the maximum value BMmax here, in order to rapidly increase the performance
second case group CG2:

$$Delta - DPD > 0 + X ,$$

i.e. the capacity is somewhat too low. According to step ST10, the operating mode BM is increased by a small value here, e.g. by 1, towards a higher performance, i.e. BM à BM+1.
third case group CG3:

$$0 + X > Delta - DPD > 0 - X ,$$

i.e. Delta-DPD is in a range of around zero or the current dew point depression c-DPD is in the range of around the target dew point depression t-DPD; according to step ST11-3; the current operating mode BM is maintained here,
fourth, lowest case group CG4: Delta-DPD<0−X, i.e. Delta-DPD is negative and small, so that the target dew point depression t-DPD is greatly exceeded and the performance is high, but with lower energy efficiency.

The operating mode BM is decreased by a value 1 towards a higher energy efficiency here.

Therefore, according to the embodiment of FIG. 5, non-linear regulation of the operating mode BM preferably takes place. According to this embodiment, an increase in the operating mode BM is performed more quickly than a decrease, whereby a high level of safety is in turn ensured.

Subsequently, according to step ST11, in the new operating mode BM, the regeneration phases are then carried out, i.e. the activation of the regeneration valve device 9 takes place as a result of the control signal S3, which—as indicated in step ST12-produces a new state of the air dryer unit 8. The method is therefore reset, in that, according to step ST7, the resultant current dew point depression c-DPD is ascertained and compared with the—possibly meanwhile newly calculated-target dew point depression t-DPD in step ST8.

### List of Reference Signs (Part of the Description

1 Utility vehicle
2 Compressed air system
3 Compressed air supply device
4 Consumer stage
6 Compressor
8 Air dryer unit
8a Dryer inlet
8b Dryer outlet
9 Regeneration valve device
10 Electronic control unit ECU
10a Interface
11 Outlet region of the compressed air supply device 3
12 Multi-circuit protection valve
13 Compressed air
14, 15, 16, 17 Consumer circuits
14, 15 Service brake circuit
18, 19 Compressed air reservoir
20 Compressed air outlet
21 Pressure sensor
22 Internal humidity sensor in the compressed air supply device 3
23 External humidity sensor in the compressed air supply device 4
24 First non-return valve between the dryer outlet 8b and the outlet region 11
25 Throttle
26 Second non-return valve in the regeneration path 31
31 Regeneration path
S2 Humidity measurement signal
S2 Pressure measurement signal
S3 Control signals
S4 Compressor control signals
DP Dew point
rf Humidity, in particular relative humidity
DPD Dew point depression
t-DPD Target dew point depression
c-DPD Current dew point depression
Delta-DD DPD deviation
GPS Position signals
Mission data, map data MD
T(t) Ambient temperature at time t
T(0) Current ambient temperature
T(t, GPS) Ambient temperature at the time at position GPS or at the position of the GPS signal
ac Air consumption of the vehicle systems. e.g. of air springs, brake systems, gear actuators
v Vehicle speed
rt Journey time
tss Projected duration
tpss Projected times

1. A method for controlling a compressed air supply device of a compressed air system of a utility vehicle, the compressed air supply device comprising:
a compressor, an air dryer unit and a regeneration valve device, the compressed air supply device being operated in an operating mode with delivery phases and regeneration phases, compressed air being delivered by the compressor, guided through the air dryer unit and dried thereby in the delivery phases, and dried compressed air being conducted through the regeneration valve device and the air dryer unit in the regeneration phases,
wherein
a current humidity is ascertained in the compressed air system,
a current dew point depression is ascertained from the ascertained humidity,
a target dew point depression is ascertained,
from current and/or projected ambient temperature data, and/or
from current and/or projected vehicle operating data, the target dew point depression is subsequently compared with the current dew point depression, and
the operating mode is set and/or changed subject to the comparison.

2. The method as claimed in claim 1, wherein the duration and/or number of the regeneration phases is/are altered or set subject to the comparison in the operating mode.

3. The method as claimed in claim 1, wherein a current dew point is ascertained from the ascertained humidity and the current dew point depression is ascertained from the current dew point.

4. The method as claimed in, wherein the humidity is measured at one or more of the following points:
in an outlet region of the compressed air supply device between the air dryer unit and consumer circuits of a subsequent consumer stage,
in a regeneration path between the regeneration valve unit and a dryer outlet of the air dryer unit;
in one of the consumer circuits, e.g. a compressed air reservoir of the consumer circuits.

5. The method as claimed in claim 1, wherein a relative humidity or an absolute humidity is measured as the humidity value in the compressed air.

6. The method as claimed in claim 1, wherein, to ascertain the target dew point depression, one or more elements of the group comprising:
current ambient temperature data,
projected, future ambient temperature data,
current position data in a global position system,
projected, future position data, and/or
map data or one or more planned journeys,
are furthermore included.

7. The method as claimed in claim 6, wherein a future dew point is ascertained from
the position data, and
the map data for a planned journey, in particular taking into account the ambient temperature along the route.

8. The method as claimed in claim 1, wherein the current and/or projected vehicle operating data comprise some or more elements from the group comprising:
air consumption of vehicle systems, e.g. of air springs, brake systems, gear actuators,
vehicle speed, journey time, route planning, projected durations and/or times of vehicle standstills.

9. The method as claimed in claim 1, wherein the operating mode and/or the target dew point depression is/are ascertained using a target energy efficiency and a target capacity.

10. The method as claimed in claim 1, wherein the ascertained target dew point depression is subsequently regulated by calculating a dew point deviation, which is ascertained as a difference between the target dew point depression and the current dew point depression,
the control of the regeneration phases taking place subject to the dew point depression deviation,
the current operating mode being maintained in the event that the dew point depression DPD deviation is within a limit value range of around zero, and
the operating mode being changed towards longer regeneration phases and/or a higher number of regeneration phases in the event that the dew point depression deviation is above the limit value range, and
the operating mode being changed towards a higher energy efficiency by shortening or decreasing the regeneration phases, in the event that the dew point depression deviation is below the limit value range.

11. The method as claimed in claim 10, wherein a second upper limit value is specified above the limit value range, and
the operating mode is set to a maximum regeneration capability in the event that the dew point depression deviation is above the second upper limit value.

12. The method as claimed in claim 10, wherein, after the operating mode is set, a measurement of the current dew point depression takes place, and the method is subsequently reset to ascertain the dew point depression deviation.

13. The method as claimed in claim 1, wherein the operating mode is furthermore set subject to a compressed air requirement, which is ascertained from:
pressure signals of a consumer stage, in particular of at least one pressure sensor in a compressed air reservoir of a consumer circuit, and/or
a theoretical ascertainment on the basis of the delivery phases, regeneration phases and actuations of consumers of the consumer stage.

14. A compressed air supply device for a compressed air system of a utility vehicle, the compressed air supply device having:
a compressor for delivering compressed air,
an outlet region for connection to a consumer stage with consumer circuits,
an air dryer unit, which is provided between the compressor and the outlet region,
an electronic control unit, which is designed to set an operating mode with at least delivery phases and regeneration phases, and
a regeneration valve device, which is connected to the outlet region and can be activated by the electronic control unit to form the delivery phases for delivering compressed air through the air dryer unit to the outlet region and the regeneration phases, in which the delivered, dried compressed air is returned from the outlet region through the air dryer unit,
wherein
the electronic control unit is designed to read in a humidity measurement signal indicating a current humidity and to ascertain a current dew point depression from the humidity measurement signal,
to ascertain a target dew point depression from current and/or projected ambient temperature data,
to compare the target dew point depression with the current dew point depression and to set and/or change the operating mode and/or the regeneration phases subject to the comparison.

15. The compressed air supply device as claimed in claim 14, wherein the electronic control unit is designed to read in the humidity measurement signal from an internal humidity sensor of the compressed air supply device, which is provided at one or more of the following points:
in the outlet region,
between an air dryer outlet of the air dryer unit and the outlet region,
downstream of a throttle of the regeneration path as seen in the flow direction.

16. The compressed air supply device as claimed in claim 14, wherein the electronic control unit is designed to read in the humidity measurement signal from an external humidity sensor provided in the compressed air system.

17. A compressed air system, which has:
a compressed air supply device as claimed in claim 13,
a consumer stage with a multi-circuit protection valve and multiple consumer circuits.

18. The compressed air system as claimed in claim 17, wherein a pressure sensor and/or an external humidity sensor is/are provided in or on a compressed air reservoir of a consumer circuit.

19. A utility vehicle, having a compressed air system as claimed in claim 18.
